(19) United States
(12) Patent Application Publication
(10) Pub. No.: US 2004/0264919 A1
(43) Pub. Date: Dec. 30, 2004

(54) Display system for views of video item

(75) Inventors: Christopher Taylor, London (GB); David Anthony, New York, NY (US)

Correspondence Address: WINSTEAD SECHREST & MINICK P.C., PO BOX 50784, DALLAS, TX, 75201, US

(73) Assignee: Impressive Ideas Ltd., London (GB)

(21) Appl. No.: 10/867,016

(22) Filed: Jun. 14, 2004

(30) Foreign Application Priority Data
Jun. 14, 2003 (GB) 0313866.6

(51) Int. Cl. H04N 5/781

(52) U.S. Cl. 386/46; 386/125

(57) ABSTRACT

The invention relates to a system and method of providing the generation, storage and subsequent display of video representing a video item. The video item can be any event such as a concert, sports event or the like. In accordance with the invention, video camera are provided at at least two different locations and directed to record video of the video item from their respective locations. The video data for each location is stored on a video track of a recording medium such as a DVD. When the DVD is inserted into apparatus for decoding the data and generating a display on screen, the user can select which of the available views of the video item they wish to view.

### CROSS-REFERENCE TO RELATED APPLICATION

This application claims priority under the Paris Convention to Great Britain Application No. 0313866.6 filed on Jun. 14, 2003.

### BACKGROUND OF THE INVENTION

The invention to which this application relates is to the provision of recorded data, said data comprising video, audio and/or auxiliary data in a digital format and relating to a particular video item such as an event. The data is provided on a recording media, such as for example a DVD, with the data providing a series of versions of the video item, from which a particular version for display of the video item can be selected by a user.

The provision of DVD's is now well known and is increasingly superseding video tape and other forms as the most commonly used format for video and audio data. The DVD is a recording media disc onto which digital data can be transferred and held and, when inserted into a DVD player, the user can control, typically via a remote control device and infrared signals therefrom, the display of video and/or audio generated from the stored data on the DVD.

The DVD itself, in order to comply with the internationally recognised standards, allows up to 8 video data tracks, 8 audio data tracks and up to 32 auxiliary data tracks to be stored thereon. The auxiliary data tracks are most typically used for subtitle information for different language versions of the audio. The range of audio tracks available can typically be used, for example, for carrying audio data for the main or normal audio for the video item, for a director's commentary on the video item, for the provision of particular version of the audio such as a no-swearing option, and so on as required.

The video data tracks which are available can be used in a number of ways such as a first track carries the data for the standard video version of the video item of the DVD, other video tracks may be produced to carry outtakes which are not included in the standard version, and/or interviews with persons appearing in the video item, to give two examples.

In the filming of video items such as, for example, concerts, sports events and the like, it is known to use a number of video cameras, with the cameras provided to each recording the video item from a particular location which differs from the others in terms of height and/or angle with respect to the item being filmed. The purpose of this number of cameras is to try and provide the best possible views of the item at each instant. Conventionally the particular view of the video item which is shown and available to the viewer at any one time when the viewer is looking at the video item generated from data on a recording media such as a DVD, has been previously decided upon by the producer or director of the filming of the video item. This is done by the producer or director looking at all of the video feeds from the available cameras and selecting one feed and hence view for each instant and then joining together the selected views in sequence to form the video display of the video item which is stored on the DVD. Thus, while the producer or director has available all of the camera feeds at the time of the event taking place, when viewing the subsequent recording of the video item, the viewer via the DVD or other media recording device, only has available the combined views sequence defined by the producer or director.

### SUMMARY OF THE INVENTION

Consequently, to both enhance the art and address the above noted deficiencies, the objective of the present invention is to provide to the viewer of a recorded video item, the ability, via the recording medium, to select to view the said video item from one of a range of viewer selectable locations thereby allowing different angles and/or heights. A further objective is to allow the selection to be changed during viewing and the selection to be made via the apparatus used to decode the data from the recording media, said apparatus in the form of, for example, a DVD player.

In a first aspect of the invention, there is provided a system for recording, storing and playing, digital data, said system including means for generating the video data, a recording media, a device for decoding the recording media to retrieve data stored on the recording media and generating a video display on a screen connected thereto, said recording media including stored therein video digital data for a defined video item, and when a viewer selects to use said recording media at least two selectable options are available to the viewer, said options defined by at least two video data tracks on the recording media and characterised in that the at least two video data tracks include data for the same video item, each of said tracks comprising a view of the video item from a location at a different angle and/or height with respect to the video item.

Typically the viewer is provided with a selection means to allow the selection to view video data from one of said video tracks.

In one embodiment, the video item is an event in the form of any of a television programme, film, sports events, concert or the like which is recorded and the data stored on the recording media.

In one embodiment the recording media is a DVD.

Typically, when the video item is initially selected for viewing, a default video track on the recording media starts to be decoded by the apparatus and a video display generated on screen. The default video track can be for a particular angle or viewing height of the event, such as, for example, the front view. If the invention is activated at that time, a selection display is also generated on the screen, typically to the side, top or bottom of the screen, said selection display indicating each of the views of the video item which are available and the viewer can navigate along each of the said video track displays using the selection means. If they wish to select one of the other available views from that which is currently being generated, a selection signal is generated by moving the cursor or highlighted portion on the selection display to the appropriate view display and a selection signal is generated. Upon receipt of the selection signal the decoding apparatus identifies the appropriate video data track on the recording media for that view and then proceeds to decode the data from that video data track, allowing the subsequent generation on the screen of the selected view of the video item.

In one embodiment, the video data tracks include data representing views spaced 360° around the video item such that for example, if there are 8 video tracks available, when the video item is taking place, eight cameras are angularly spaced and located with respect to the item being filmed and directed to said video item. Each of the video data feeds from the cameras is then recorded on a respective video data track on the recording media. As a result, in this example, the selection display on screen will include eight display segments, each representing one of the eight video data tracks.

In a preferred embodiment the selection display comprises a seamless 360 degree view of the display. However for the purpose of selecting which view to watch, the same is in fact split into side by side segments positioned side by side, in a line, if the views are all from the the same height or are of the same angle but of differing heights.

It is envisaged that the invention is of particular utility with regard to video items in the form of live events which are filmed and subsequently recorded onto the recording media for purchase and display at a later date, such live events including sports events and concerts.

In one example, for a concert, the eight video cameras can be positioned 45° apart around the concert performer therefore providing views from the front towards the back, from the back towards the front and from each side, each of said views being recorded onto a particular video track and then available for selection by the viewer subsequently. With regard to sports events, the video cameras may include a number which are angularly spaced around a sports field but also a number which may be at different heights.

Typically, if the video data tracks which are available represent a combination of views from differing heights and angular spacing then the selection display on screen may take the form of a cross. In each case, the selection display can be navigated via a selection means, which most typically will be in the form of a remote control device which can be held by the viewer and, the recording media apparatus, upon receipt of infrared or other signals from the remote control device, provides a highlighted portion or cursor which moves with respect to the selection display. When a particular display segment is reached and selected, the recording media apparatus receives a signal and accesses the particular video track on the recording media and starts to process the data thereon to generate the main screen display.

In a further aspect of the invention there is provided a method for generating a series of video views of a video item, said method comprising the steps of capturing and generating video data for at least two different views of the video item, allocating the video data for each view onto a video data track of a recording media, said recording media, when inserted into decoding apparatus, allowing the generation of video from user selected available video tracks and wherein the user is provided with selection means to select to view the video item by selecting one of the views to allow the generation of video from the video data track matching the selected view on a screen connected to the decoding apparatus.

In a preferred embodiment the method includes the step of generating on a display screen connected to the decoding means, a selection display, said display including a number of segments each segment representing one of the available views.

In one embodiment, each of the segments includes a moving display generated from the video data track for that particular view.

In a further aspect of the invention there is provided a video processing system for the generation of a video display on a display screen, said processing system processing said data in response to a user selection of any one of a number of video data tracks on a recording medium, said video tracks having data relating to the same video item and wherein, when activated, the display on the display screen includes a selection display representing each of the video data tracks available and the user is provided with control means to allow an indicator to be moved on screen with respect to said selection display to allow one of said video data streams to be selected by the user and generated on the screen, each of said video data tracks representing a view of the video item from a different location.

While this selection display is described herein with respect to the use in conjunction with a DVD it should be appreciated and the patent interpreted such that selection display can be used with other video processing means such as a CD/DVD ROM application as well as for other dedicated video playback devices as the selection display herein described is a very effective way of navigating through a range of video images of the same event such as 360 degree video.

In one embodiment the selection display is generated using picture in picture (PIP) technology.

### BRIEF DESCRIPTION OF THE FIGURES

FIGS. 1A-B illustrate plan, schematic views of two embodiments of the filming of an event in accordance with the invention;

FIG. 2 illustrates, in schematic form, the apparatus utilised for the invention in one embodiment;

FIGS. 3 and 4 illustrate views of the display screen in accordance with the invention;

FIGS. 5-7 illustrate one method by which the images received from the cameras can be processed to form the screen display and selectable images in accordance with the invention.

FIG. 8 illustrates how for each frame, with the selection display generated as herein described the same is superimposed.

### DETAILED DESCRIPTION OF THE INVENTION

Specific embodiments of the invention are now described with respect to the accompanying drawings.

While the making and using of various embodiments of the present invention are discussed in detail below, it should be appreciated that the present invention provides for inventive concepts capable of being embodied in a variety of specific contexts. The specific embodiments discussed herein are merely illustrative of specific manners in which to make and use the invention and are not to be interpreted as limiting the scope of the instant invention.

The claims and the specification describe the invention presented and the terms that are employed in the claims draw their meaning from the use of such terms in the specification. The same terms employed in the prior art may be broader in meaning than specifically employed herein. Whenever there is a question between the broader definition of such terms used in the prior art and the more specific use of the terms herein, the more specific meaning is meant.

While the invention has been described with a certain degree of particularity, it is clear that many changes may be made in the details of construction and the arrangement of components without departing from the spirit and scope of this disclosure. It is understood that the invention is not limited to the embodiments set forth herein for purposes of exemplification, but is to be limited only by the scope of the attached claim or claims, including the full range of equivalency to which each element thereof is entitled.

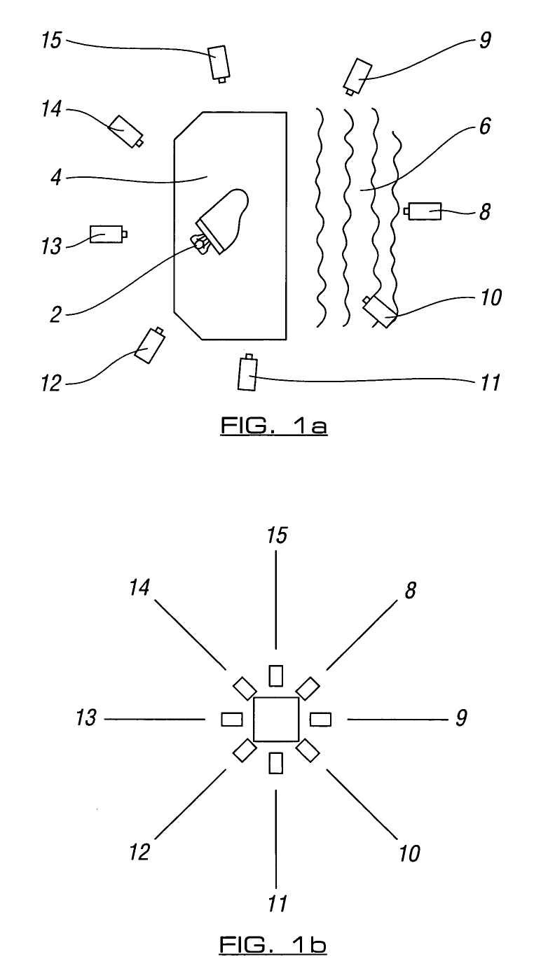

Referring firstly to FIG. 1A there is illustrated the manner in which a video item in the form of an event, in this case a musical concert, would be filmed in accordance with one embodiment of the invention with the figure in plan to illustrate the layout of the video cameras used. The performer 2 is performing on a stage 4 with an audience 6 positioned at the front of the stage. To film the event eight video cameras t cameras are provided 8-15, each spaced equally apart in this embodiment as shown in FIG. 1A.

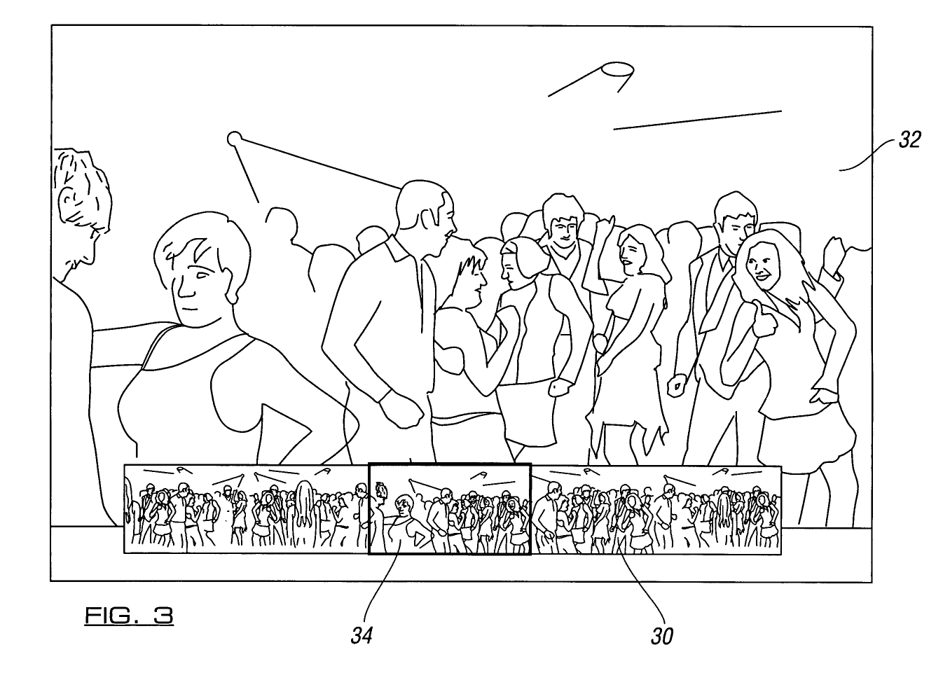

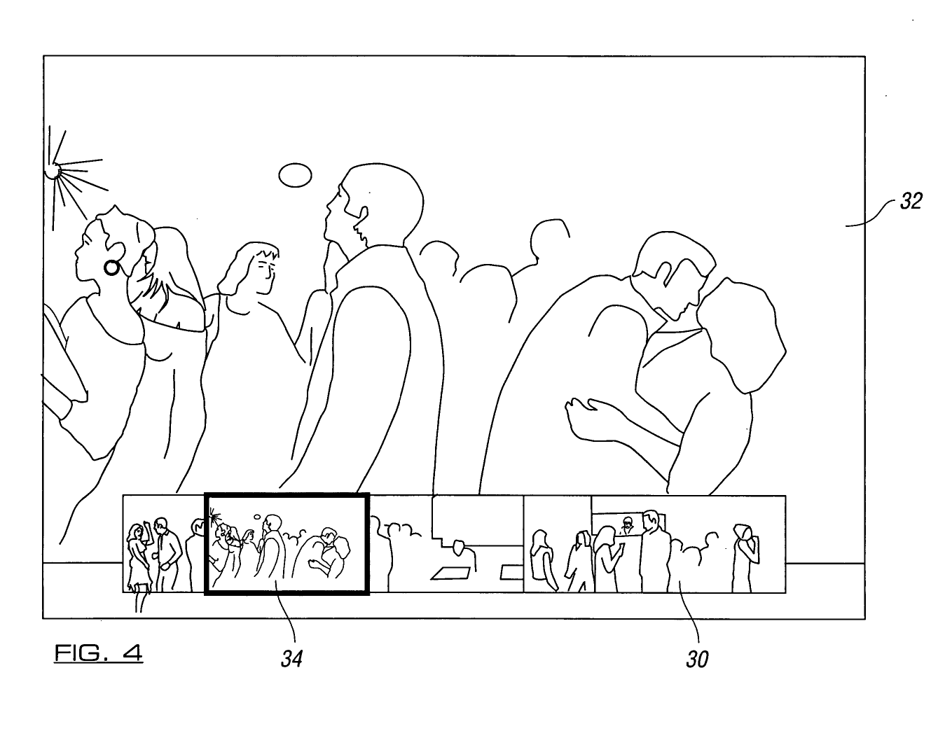

However as an alternative embodiment as shown in FIG. 1B rather than the cameras being spaced around the video item, the cameras 8-15 are provided in a cluster pointing towards angled mirrors (not shown) which in turn allow each camera to capture a video image which each represents part of the 360 degree angle surround. This arrangement will be described in more detail with reference to FIGS. 3 and 4.

Thus, during any performance each of the cameras generates video data representing their particular view and this data is stored and after any necessary editing, the video data for each view is stored on a video data track for subsequent collection of the tracks on a recording media, such as a DVD. The video data tracks therefore represent the video item of the concert for the recording media on sale.

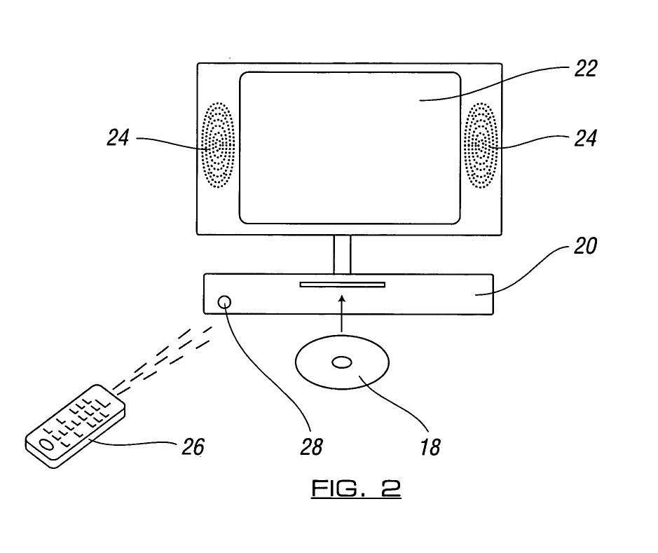

When purchased, the recording media, hereinafter referred to in a non-limiting manner as a DVD is inserted into apparatus as illustrated in FIG. 2. The DVD 18 is inserted into a suitable apparatus, in this case a DVD player 20 which includes a decoder. The DVD player is provided with, or connected to, a display screen 22 for display of the video and speakers 24 for generation of the audio. Once inserted the subsequent operation of the DVD player can be controlled via keys on the housing of the player 20 but more typically by keys on a remote control 26 which operates in a conventional manner emitting an infra red signal received by the receiver 28 on the DVD player.

When inserted and the selection to play the DVD is made, a default video data track on the DVD is used, perhaps that representing the forward view from camera 8. At the same time a selection display is generated along the bottom of the screen representing all of the available views.

In the embodiment shown in FIGS. 3 and 4, a camera rig as illustrated in FIG. 1B, with 8 DV-Cam video cameras mounted on their end and pointing up (to allow the lenses to be very close to each other) at angled mirrors is used. This allows the capturing of video 360 degrees around the location of the rig, i.e. the cameras are grouped in a cluster and, via the angled mirrors, obtain video images pointing outwardly around 360 degrees. This is the opposite to the arrangement shown in FIG. 1A. The 8 resulting video streams each represent a portion of the 360 degrees panorama and have some overlap, but represent the full panorama. Still frames from each of the angles are obtained and stitched together into panoramic frames.

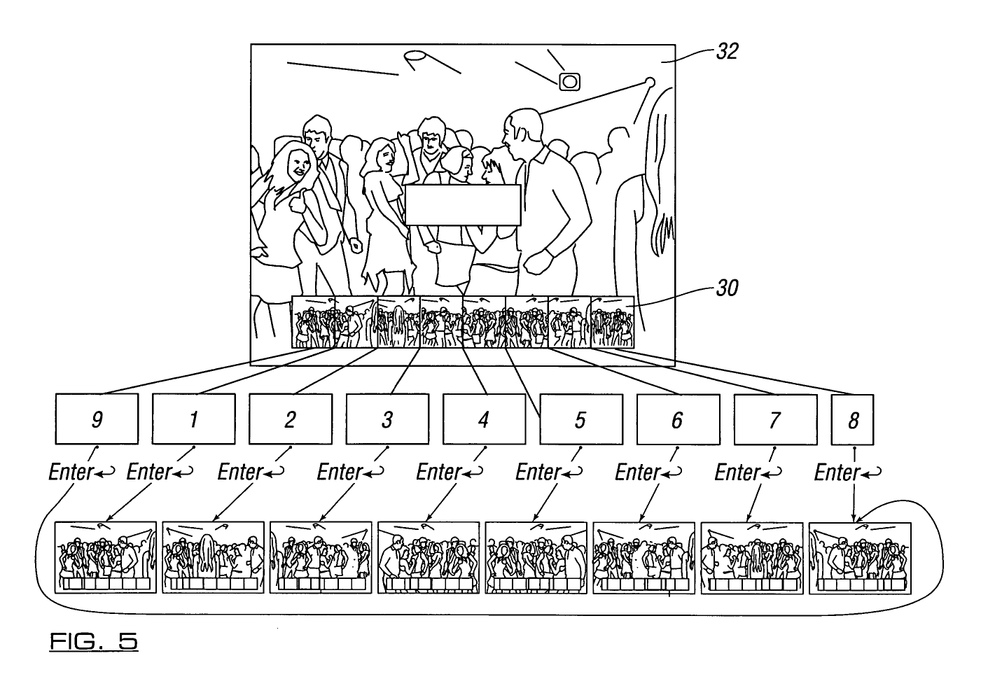

The panoramic frames are then used to create video again so as to create a panoramic video stream for the generation of the selection display by mapping the same onto each of the video data tracks for the available views. The eight data streams for respective views are then able to provide a multi-angle video selection of the video item which can be navigated and selected via the selection display 30 and the viewers remote control. One process for achieving this is given in more detail with reference to FIGS. 5-7.

The display generated is illustrated with respect to FIGS. 3 and 4 which show a crowd scene taken from a number of views to generate a panoramic view, said views represented by the selection display 30 at the bottom of the main display screen 32. It will be seen that in each case the segment of the selection display which is highlighted 34 at that time represents the selected view, and it is the date for that view which is generated across the entire screen.

In this example the viewer navigates the 360 degrees of video by way of miniature video version of the entire panoramic selection display 30 that is at the bottom of the screen as the selection display. They choose the view that they want by way of a highlight overlay 34 that they can move from left to right and back across the selection display. When they get to the view of the panoramic that they want to see, the user presses “enter” on their remote control and that portion of the panorama comes up on screen. They continue in this way, moving the highlight curser 34 over the selection display and selecting and viewing any portion of the video panorama. It is preferred that the display generated is of a seamless letterbox form as shown, and indeed this selection display can be utilised for other video processing systems.

With the selection display shown in FIGS. 3 and 4 it is the FIG. 1b arrangement which is represented. For the FIG. 1a version where the cameras face inward, the positioning of items in each camera video image would be different picture to picture, as the different cameras show a different view of the same thing. In this arrangement the display can be generated in other formats, such as a series of picture “boxes”, each representing one of the views.

Turning now to FIGS. 5-7 there is illustrated one method and process by which the video images from each of the cameras can be collated and processed to form the selection display and then the selection display 30 superimposed on the video frames used for generating the full screen display 32 following user selection.

With reference to FIG. 5, each of the numbered boxes 1-7 represents a video segment and, on screen the segments are overlapped to form the selection display 30 as shown. The viewer can navigate between the segments by pressing the left and right arrow keys, (or up and down keys if required) on their remote control to suit the orientation of the selection display. Each of the segments is in turn associated with a particular angle of view of the event and the selection of that segment by the viewer causes the DVD player to switch to the video data stream which represents the particular selected angle of video associated with the segment.

The command is typically executed when the viewer presses the Enter, OK, or another designated key on the remote control device. Alternatively, if for example the DVD is being played on a computer the Viewer can click on a button via the mouse to execute the command and the segment selected at that time is used to associate to the appropriate video data track for the generation of the full screen display from the selected viewing angle. With regard to the segments 9 and 1, segment 9 overlaps the segment 1 and when selected actually activates the video display for the viewing angle given by segment 8.

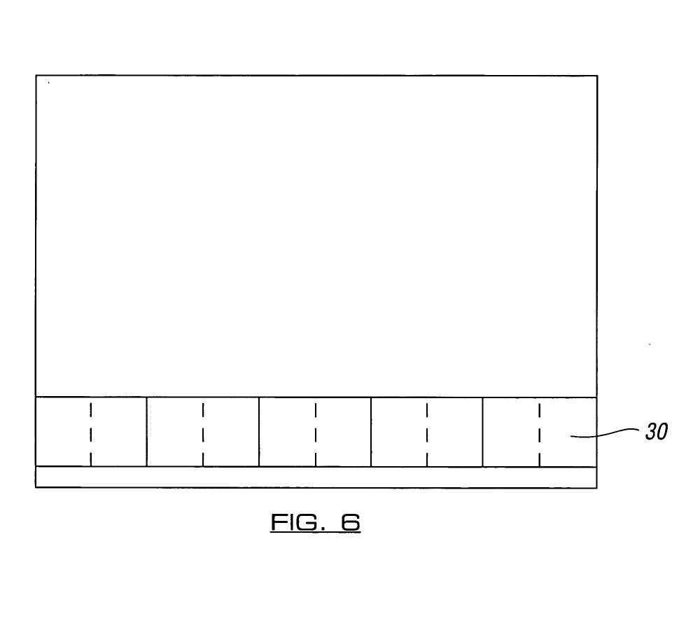

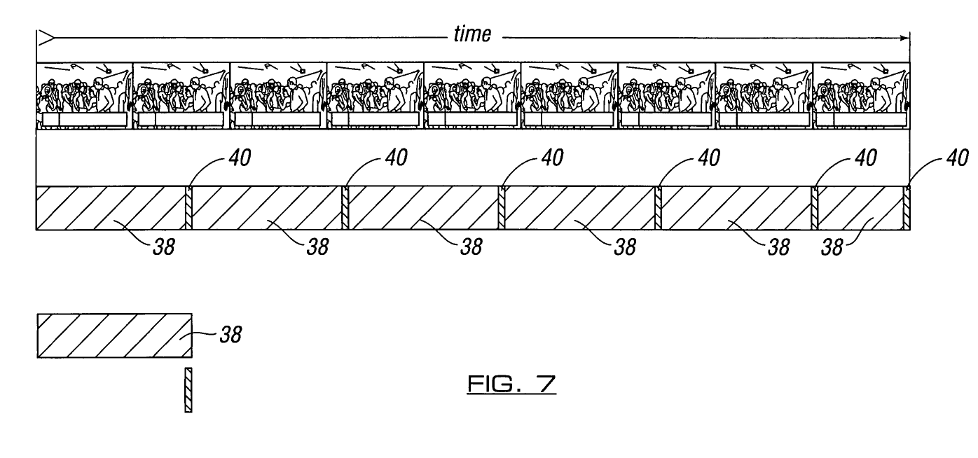

Upon selection of a particular video display, the selection display is generated to show the current content of all of the available video angles represented by the segments. The actual angle which is being displayed on the full screen is illustrated by the highlighting 34 of one segment, with the highlighted area moveable in response to the viewers key selections. FIG. 6 illustrates how an overview can be generated which groups the segments into two groups, an odd numbered group in which the blue (full lines for purposes of illustration) are ignored, and a second even numbered group of segments where the red (broken lines for purposes of illustration) are ignored. FIG. 7 illustrates how, with the picture track overlay, the same can be populated with video with respect to time. In this case the track comprises a series of subpictures 38 which include segments and these are interspersed with subpictures 40 without segments, amounting, in total to 12 frames or subpictures in duration.

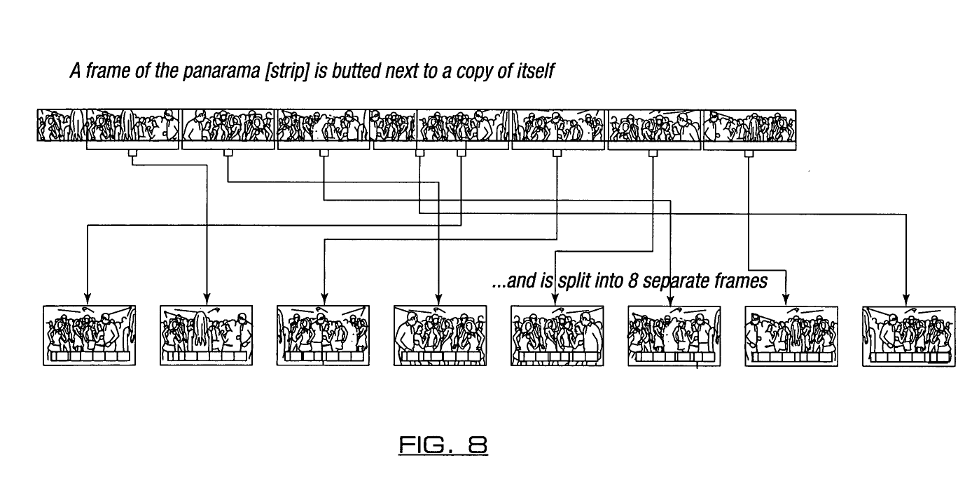

FIG. 8 illustrates how for each frame, with the selection display generated as herein described the same is superimposed. Each data group represents a particular camera viewing angle and so for each of the eight groups, the frames in the groups have the selection display imposed thereon. The groups are collected and transcoded into an MPEG2 compliant stream and brought into a DVD video authoring programme. Thus when the frames for a particular group and hence video stream are selected, the selection display is viewable.

When a view is selected from the selection display the select signal is transmitted and the DVD player identifies the appropriate video data track on the DVD for that view and generates the video display across the screen thus showing to the viewer the required view of the event.

1. A system for recording, storing and playing digital data, such system including means for generating the video data, a recording media, a device for decoding the recording media to retrieve data on the recording media and generating a video display on a screen connected thereto, said recording media including stored therein video digital data for a defined video item, and when a viewer selects to use said recording media at least two selectable options are available to the viewer, said options defined by at least two video data tracks on the recording media and characterised in that the at least two video data tracks include video data for the same video item, each of said tracks comprising a view of the video item from a location at a different angle and/or height with respect to the video item.

2. A system according to claim 1 wherein the viewer is provided with a selection means to allow the selection of one of said video tracks to be viewed on the screen.

3. A system according to claim 1 wherein the video item is an event which has been filmed and the data recorded onto and stored on the recording media.

4. A system according to claim 1 wherein one of the video tracks is defined as a default video track which upon selection of the video item is decoded by default and a video display generated on screen from the data on said default video track.

5. A system according to claim 4 wherein the default video track is the date of the event recorded from a predefined angle or viewing height of the video item.

6. A system according to claim 5 wherein the view which is generated is from a location which provides a front view of the event.

7. A system according to claim 1 wherein a selection display is generated on the screen, said selection display indicating each of the video track views of the video item which are available for selection.

8. A system according to claim 7 wherein the viewer can navigate along the said selection display using selection means which interact with the apparatus for decoding and generating the video display.

9. A system according to claim 8 wherein the user can select one of the video item views by generating a selection signal when a cursor or highlighted portion on the selection display is at the appropriate location.

10. A system according to claim 9 wherein the selection signal is generated via a selection means in the form of a remote control device.

11. A recording media according to claim 1 wherein the video data tracks include data representing views from locations spaced 360 degrees around the video item.

12. A system according to claim 11 wherein eight locations are positioned 45 degrees apart around the video item.

13. A system according to alarm 11 at each location there is provided a video camera directed at the video item.

14. A method for generating a series of views of a video item, said method comprising the steps of capturing and generating video data for at least two different views of the video item, allocating the video data for each view onto a video data track of a recording media, said recording media, when inserted into decoding apparatus, allowing the generation of video from user selected available video tracks and wherein the user is provided with selection means to select to view the video item by selecting one of the views to allow the generation of video from the video data track matching the selected view on a screen connected to the decoding apparatus.

15. A video processing system for the generation of a video display on a display screen, said processing system processing said data in response to a user selection of any one of a number of video data tracks on a recording medium, said video tracks having data relating to the same video item and wherein, when activated, the display on the display screen includes a selection display representing each of the video data tracks available and the user is provided with control means to allow an indicator to be moved on screen with respect to said selection display to allow one of said video data streams to be selected by the user and generated on the screen each of said video data tracks representing a view of the video item from a different location.

16. A recording medium, said medium including a plurality of video tracks, a plurality of said tracks including video data, the video data on each of said tracks representing a view from a particular location of a common video item.
